(19) United States
(12) Patent Application Publication
(10) Pub. No.: US 2026/0290933 A1
(43) Pub. Date: Sep. 24, 2026

(54) BATTERY ENERGY STORAGE SYSTEM CHILLER CAPACITY EXPANSION

(71) Applicant: Fluence Energy, LLC, Arlington, VA (US)

(72) Inventors: Hariram Patel, Bangalore (IN); Kashyap Subramanya, Bangalore (IN); Karthik Ramesh, Coimbatore (IN); Chandrasekar Ramasamy, Erode (IN)

(73) Assignee: Fluence Energy, LLC, Arlington, VA (US)

(21) Appl. No.: 19/570,468

(22) Filed: Mar. 18, 2026

Related U.S. Application Data
(60) Provisional application No. 63/775,673, filed on Mar. 21, 2025.

(51) Int. Cl. H01M 10/627; H01M 10/613; H01M 10/6569; H01M 50/204; H01M 50/251

(52) U.S. Cl. CPC H01M 10/627; H01M 10/613; H01M 10/6569; H01M 50/204; H01M 50/251; H01M 2220/10

(57) ABSTRACT

A method and system for an energy storage system (ESS) cooling capacity expansion includes a plurality of battery modules situated within an enclosure. The enclosure includes an integrated chiller unit including a first condenser, a first compressor, a first evaporator, an expansion valve, and an external coupling for an add-on cooling unit. A coupling is used to connect the first condenser and the add-on cooling unit. The add-on cooling unit is external to the enclosure. The coupling includes an electrical connection and a refrigerant connection. The add-on cooling unit includes a second condenser, absent a second compressor and a second evaporator.

### CROSS-REFERENCE TO RELATED APPLICATIONS

The present application claims the benefit of priority to United States Provisional Application No. 63/775,673 filed on Mar. 21, 2025, which is hereby incorporated by reference in its entirety.

### INTRODUCTION

The concepts described herein relate to a battery energy storage system (ESS), and more specifically, to an ESS cooling system expansion.

A modular ESS includes multiple individual energy storage enclosures interconnected to provide varied levels of storage capacity. Energy storage systems can be used to store additional power produced by an external power source during periods of reduced demand and provide additional power to external power sources during periods of increased demand.

Each individual energy storage enclosure includes multiple battery packs. Each battery pack in turn includes multiple modules made up of individual battery cells disposed adjacent to one another. A battery pack may contain multiple series-connected battery modules and an enclosure/cube that may contain multiple parallel-connected battery packs. A node as used herein may contain one or more enclosures/cubes. Further, a core may contain multiple parallel coupled nodes. As each battery cell may produce heat, the enclosure/cubes may also require some type of cooling system. Cooling systems may typically include the use of compressors, evaporators, and condensers with fans to move air across various coils. However, fans produce noise, especially as the size of an ESS increases or when expanded cooling capacity is desired, e.g., when cooling an ESS in a hot operating environment.

### SUMMARY

Disclosed herein are systems and methods for an energy storage system (ESS) cooling capacity expansion. As appreciated in the art, zoning requirements may place restrictions on the amount of noise produced by a system, for example due to the proximity of residential dwellings. The present solutions therefore provide an optimized system and method for lowering the associated noise levels of an ESS cooling system and/or extend the capacity of an ESS system in harsh/hot operating environments, for instance by providing expanded cooling capacity to an ESS system enclosure.

In particular, a method for ESS cooling capacity expansion is disclosed herein that includes identifying an ESS having a plurality of battery modules situated within an enclosure. The enclosure may include an integrated chiller unit having an external coupling (e.g., an electrical connection and/or a refrigerant connection) for an add-on cooling unit. The method may include coupling a first condenser with the add-on cooling unit, with the add-on cooling unit being external to the enclosure. The method may also include operating the ESS with the add-on cooling unit, where the add-on cooling unit includes a condenser, absent a compressor and an evaporator. The integrated chiller unit may include a condenser, a compressor, an evaporator, and an expansion valve.

Aspects of the method may include operating the ESS with the add-on cooling unit in a disabled state. The add-on cooling unit may be removed, leaving the ESS in an operable state.

Coupling within the scope of the method may include utilization of a first manual flow control valve situated within the enclosure, or utilization of a second manual flow control valve situated in the add-on cooling unit.

A method is also disclosed for servicing the add-on cooling unit by removing the add-on cooling unit from the ESS, e.g., using a forklift.

Also disclosed herein is a system for an ESS cooling capacity expansion. The system includes an ESS with a plurality of battery modules situated within an enclosure. The enclosure in one or more embodiments includes an integrated chiller unit that includes an external coupling for an add-on cooling unit. The enclosure may further include a coupling to connect the first condenser and the add-on cooling unit. The add-on cooling unit, which may be external to the enclosure, includes a condenser, absent a compressor and an evaporator. The ESS in some configurations may be operable without the add-on cooling unit, e.g., with the add-on cooling unit in a disabled state. The add-on cooling unit may allow the integrated chiller unit to operate in a reduced noise mode.

The external coupling may include one or more self-sealing quick connect valves, and/or a hose configured or suitable for refrigerant use. The first and second condenser may respectively include a first and second manual flow control valve.

The system in one or more embodiments may include a physical receptacle area within the add-on cooling unit configured to allow lifting of the add-on cooling unit by a lifting device.

An aspect of the disclosure may include a method for expanding ESS chiller capacity. The method may include identifying an ESS having battery modules situated within an enclosure, the enclosure having an integrated chiller unit. The integrated chiller unit may further include an expansion valve. The method may include coupling the first condenser with an add-on cooling unit that is external to the enclosure. The method may also include operating the ESS with the add-on cooling unit. The add-on cooling unit may include a condenser, absent a compressor and an evaporator. The method may include where the coupling utilizes one or more self-sealing quick connect valves, e.g., a first manual flow control valve situated in the BESS enclosure and a second manual flow control valve situated within the add-on cooling unit. The coupling may include hose suitable for refrigerant use.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an example energy storage system including a plurality of energy storage enclosures.

FIG. 2 illustrates a portion of the energy storage system of FIG. 1.

FIGS. 2A and 2B schematically illustrate non-limiting alternative example embodiments of an energy storage enclosure.

FIG. 3 is an illustration of a representative chiller/cooling system.

FIG. 4 is an illustration of a chiller/cooling system with an add-on cooling unit in accordance with an embodiment.

FIG. 5 is a perspective illustration of a cooling system with an add-on cooling unit.

FIG. 6 illustrates a set of a coupling between a BESS enclosure and an add-on cooling unit.

FIG. 7 illustrates an example method for expanding battery energy storage system chiller capacity.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

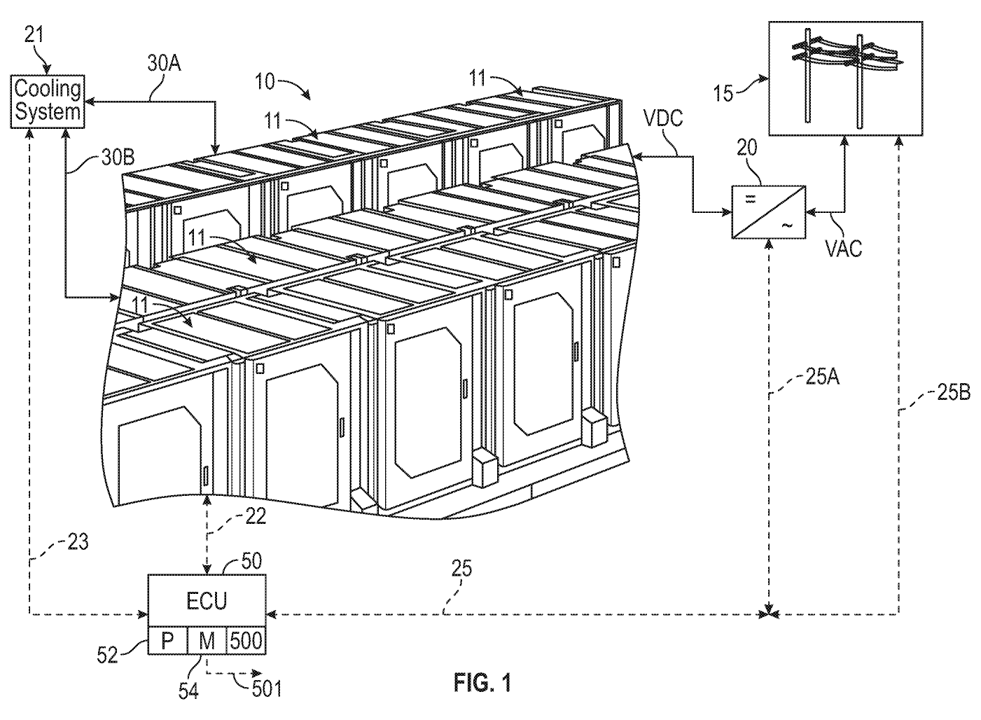

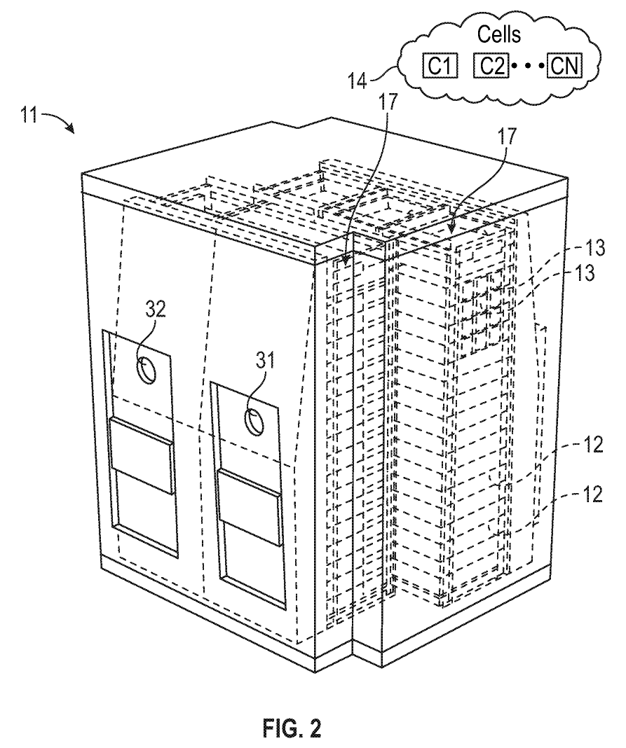

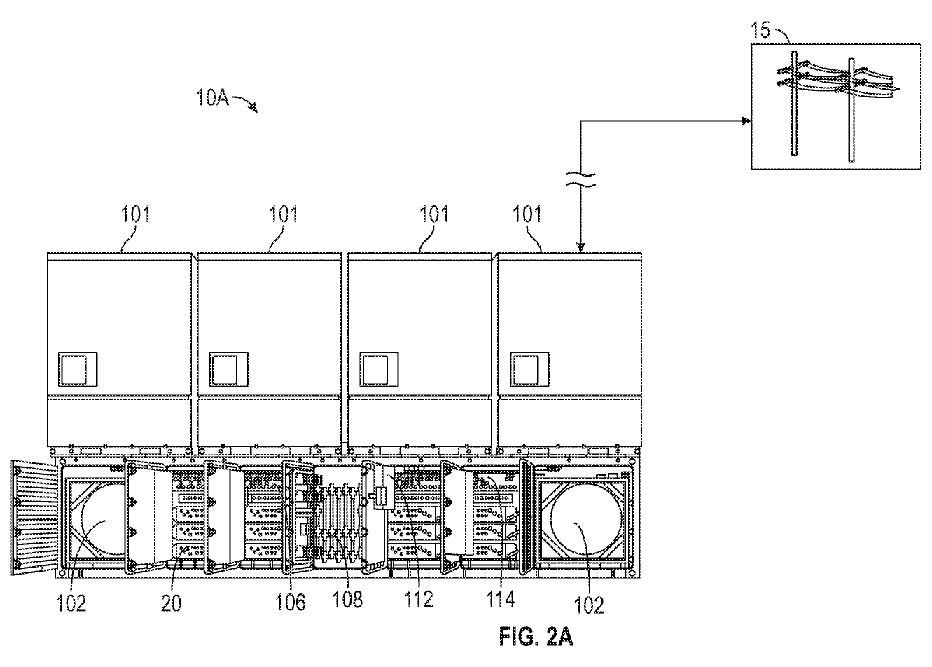

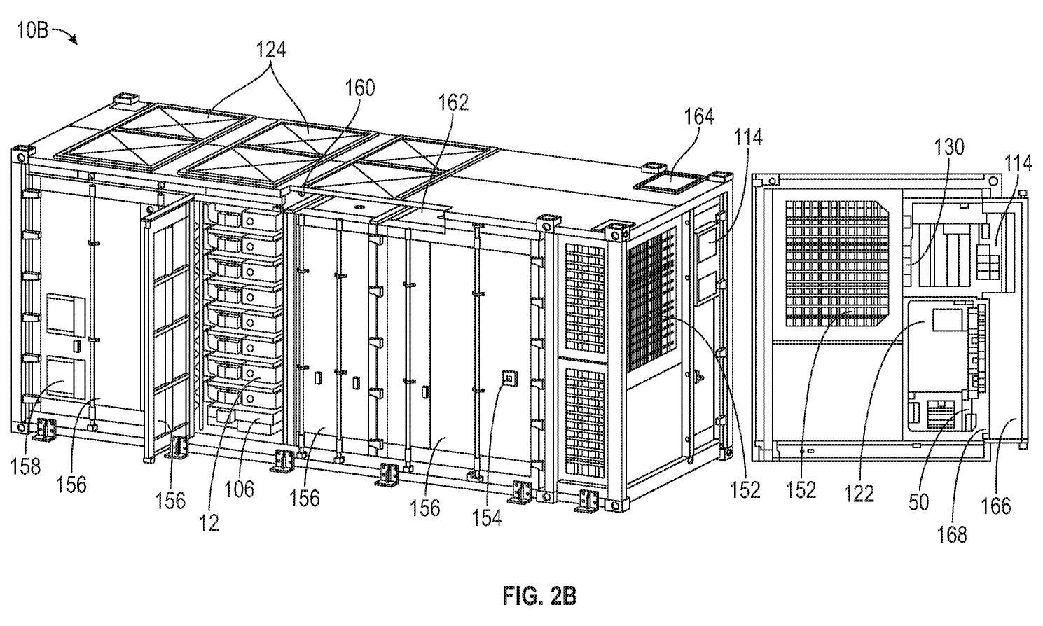

Referring to the drawings, wherein like reference numbers refer to the same or like components in the several Figures, FIG. 1 schematically illustrates an electronic control unit (ECU) 50 for use with an energy storage system (ESS) 10 having an application-suitable number of energy storage units 11. The ESS 10 of FIG. 1 is just one possible implementation, with alternative ESSs 10A and 10B described below with reference to FIGS. 2A and 2B, respectively.

Industry-wide, various grid events can lead to a sudden reduction or increase in grid voltage, i.e., a threshold voltage deviation. This in turn can cause grid-following devices such as the ESS 10 of FIG. 1 to momentarily block power or divert output to reactive support, thus causing performance issues upstream at the point of an external power source 15. Extreme voltage events can cause equipment damage. Voltage support modes tend to provide reactive power according to a setpoint, a power factor range, or a voltage range. However, only the latter can help mitigate grid-side voltage fluctuations.

A problem recognized herein is that conventional controls based on a proportional response to absolute voltage deviations will tend to command required reactive support, i.e., through reactive current injection and absorption. This may occur too late for optimal effectiveness. To help address such a problem, the ECU 50 as described herein is configured to control output power of the ESS 10 to the external power source 15, e.g., a utility grid, as needed.

The representative ESS 10 of FIG. 1, and the ESSs 10A and 10B of respective FIGS. 2A and 2B, are configured for securing, containing, and supporting a collection of battery elements, e.g., battery modules/racks 12, battery submodules 13, and/or battery cells 14 as shown in the simplified non-limiting embodiment of the energy storage units 11 shown in FIG. 2. For instance, the battery racks 12 of FIG. 2 may each having one or more battery submodules 13, which collectively form one or more corresponding electrochemical battery packs 17. Each battery submodule 13 may include one or more series-connected or parallel-connected battery cells 14, e.g., a plurality of sealed lithium-ion cells or other high-energy energy storage cells such as lithium iron phosphate, silver-oxide, nickel-zinc, nickel metal hydride, lead-acid, nickel-cadmium, etc. For illustrative simplicity and clarity, the battery cells 14 are illustrated in FIG. 2 as nominal battery cells C1, C2, …, CN, with “N” being an application-specific integer value.

The representative ESS 10 illustrated in FIG. 1 includes the energy storage units 11, each respectively controlled by a local control processor (not shown) in communication with the ECU 50, e.g., by transmitting control signals to the local control processors or processor 52, which may execute instructions from a non-transitory computer storage medium/memory (M) 54 as needed to perform the described functions. A power conversion module (=/~) 20 in this non-limiting embodiment provides alternating current (AC) voltage (VAC) and a direct current voltage (VDC) as appreciated in the art, with the ESS 10 also including the ECU 50 and a cooling system 21. The cooling system 21 may be integral with or external to the ESS 10 in different embodiments.

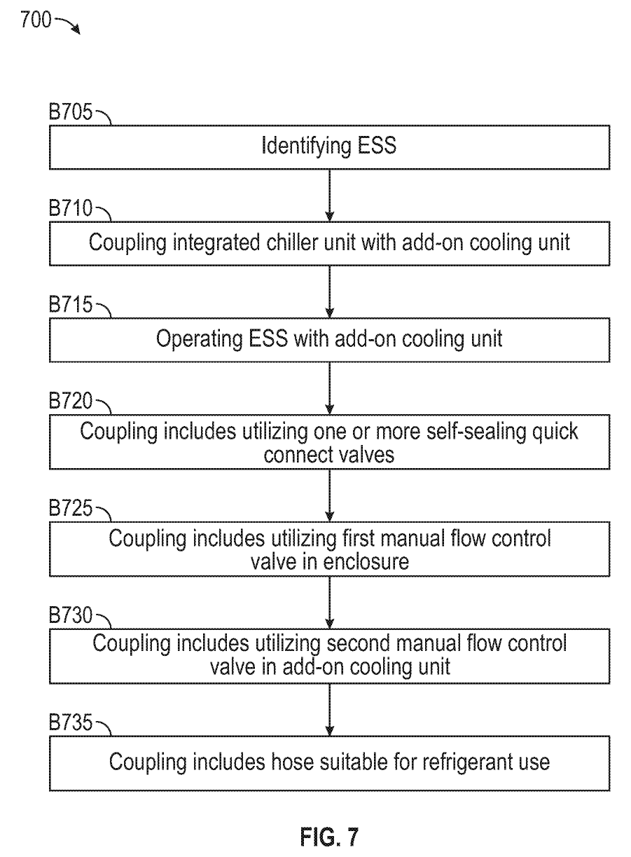

The ECU 50 of FIGS. 1 and 2 is operable for receiving input signals 22 from the ESS 10. The ECU 50 may also receive input signals 23 from the cooling system 21 and input signals 25A and 25B from the power conversion module 20 and the external power supply 15, respectively, the latter two of which may combine as input signals 25. The ECU 50 is also operable for generating output signals 501 in response to performance of a method 700, a representative embodiment of which is illustrated in FIG. 7 and described below. While the ECU 50 described below may be used with ESSs of other constructions, the ESS 10 of FIG. 1 is representative of a grid-scale, industrial strength energy storage infrastructure location/power plant, e.g., the commercially available Gridstack^{TM}.

The ESS 10 of FIG. 1 may receive AC power from the external power supply 15 in the non-limiting example embodiment of FIG. 1 when consumer demand for such power is lower than the existing/non-supplemented capacity of the external power supply 15. Conversely, the ESS 10 may offload stored electrical power to the external power supply 15 via the power conversion module 20 when demand exceeds the capacity of the external power supply 15.

In the example embodiment of FIG. 1, the power conversion module 20 remains central to power flow between the ESS 10 and the external power supply 15. Other embodiments may direct DC electrical power to the ESS 10, e.g., from solar panels or other DC power generation systems, in which case the ESS 10 may include a DC-DC converter and suitable filtering components (not shown) for regulating the level of DC power flow between the ESS 10 and the external power supply 15.

With respect to the cooling system 21, this component is coupled to the energy storage units 11 and the ECU 50 and configured to provide an application-suitable electrical coolant 30A, 30B to the ESS 10 at a relatively low first temperature. As shown in FIG. 2 for a simplified example energy storage unit 11, such coolant may be circulated through one or more inlet ports 31. The ESS 10 may also discharge coolant back to the cooling system 21 of FIG. 1 at a relatively high second temperature from at least one outlet port 32 of FIG. 2. A representative embodiment of the cooling system 21 may include a heat exchanging system having a pump, a condenser, a heat exchange, and a sump, none of which are shown but all of which are well understood by those of ordinary skill in the art.

The ECU 50 of FIGS. 1 and 2, e.g., a computer device or devices having requisite amounts and types of transitory and non-transitory memory, one or more processors, input/output circuity, etc., is in wired or wireless networked communication with the ESS 10, along with its plurality of energy storage units 11. The ECU 50 is also in communication with the power conversion module 20, the cooling system 21, and the external power source 15.

Referring briefly to FIG. 2A, a schematic front view of an example energy storage system (ESS) 10A having a plurality of modular pods 101 is shown in accordance with an aspect of the disclosure. The ESS 10A may include two cooling systems 102, the power conversion module 20, a direct current protection module (DCPM) 106, an HVAC system 114, plumbing 108, and a fire panel 112. As with the FIG. 1 embodiment, the energy storage system 10A may be coupled with the external power source 15.

In another embodiment as shown in FIG. 2B, a schematic isometric view of an ESS 10B is shown in accordance with another possible construction. The ESS 10B generally includes the ECU 50, a DCPM 106, an HVAC system 114, a DC disconnect switch 122, deflagration panels 124, an uninterruptible power supply (UPS) 130, battery modules 12, a chiller compartment 152, a fast stop (F-stop) 154, several enclosure doors 156, an inlet louver 158, multi detectors 160, a hydrogen (H₂) gas detector 162, a vent panel 164, an enclosure side door 166, and a battery cooling plate door 168, with other possible components as shown in FIG. 2A possibly present but hidden from view. These and other possible constructions for implementing the ESSs 10, 10A, and 10B of FIGS. 1-2B are disclosed in United States Patent Application Serial No. 19/359,105, filed on 15 Oct. 2025, which is hereby incorporated by reference in its entirety.

With respect to the ECU 50, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory storage medium/memory component(s) and storage devices (read only, programmable read only, random access, hard drive, etc.). The non-transitory memory component may be capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

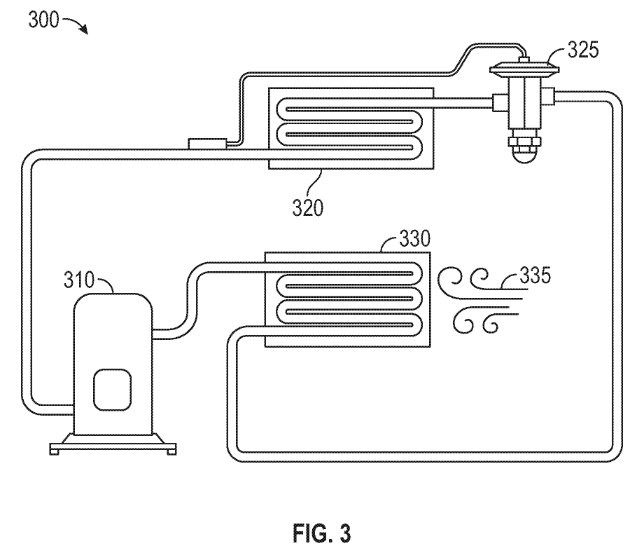

Referring now to FIG. 3, a fluid circuit diagram of a chiller system 300, also referred to herein and in the art as a vapor compression refrigeration system, is a simplified illustration showing a basic set of constituent components including a compressor 310, an evaporator 320, an expansion valve 325, and a condenser 330. Further, the condenser 330 may be cooled from an external source 335, for example one or more fans or blowers (not shown). As appreciated, a refrigeration system may function by circulating a refrigerant through a cycle of compression, condensation, expansion, and evaporation to absorb heat and produce cold, with the various components of FIG. 3 serving this purpose.

Refrigerant may be compressed and pressurized in the compressor 310, thereby turning the refrigerant into a hot gas. The refrigerant may then be sent to condenser 330 where the refrigerant transitions its state from a gas to a liquid and subsequently releases heat where the condenser 330 may be assisted in the cooling process by the external source 335, for example, one or more fans to move air over coils contained in condenser 330. The refrigerant may then pass through the expansion valve 325 where the refrigerant loses pressure and heat, becoming colder and slower. The refrigerant may then enter the evaporator 320 as a liquid where heat is absorbed from the surrounding area, turning the refrigerant back into a gas. The refrigerant may then flow back into compressor 310 where the cycle repeats.

The condenser 330 of FIG. 3 may receive high-pressure, high-temperature refrigerant vapor from the illustrated compressor 310 where the refrigerant passes through coils of the condenser 330, releasing heat and cooling down. To aid in cooling, the external source 335 may assist removing heat from the coils to aid in the cooling process. The condenser 330 may consist of a number of several types and styles, for example, air-cooled, water-cooled, and evaporative. An air-cooled condenser may utilize aluminum or copper coils to increase its surface area to boost cooling capacity. Water-cooled condensers may, instead of air, use water to cool the refrigerant. Alternatively, evaporative condensers may use a combination of water-cooled and air-cooled features.

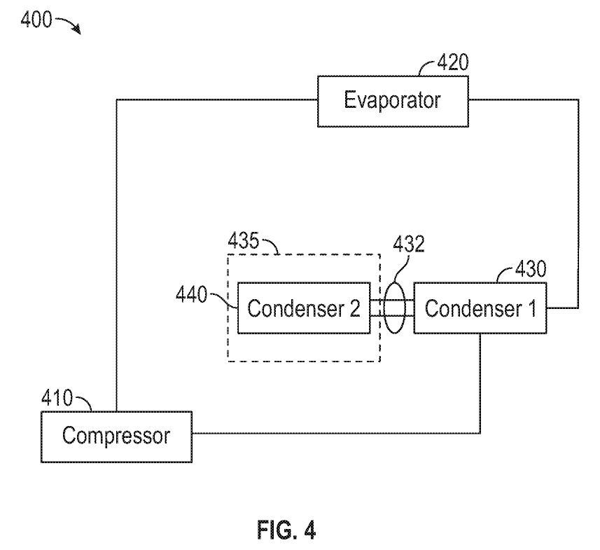

Additional cooling capacity may be achieved by increasing the surface area of the condenser 330. The additional cooling capacity may also be achieved by increasing the flow of air or water over the coils of the condenser 330. However, increasing the flow of air over the coils may require an increase in the speed of fans being used to cool the condenser 330, which may also result in an increase in the amount of noise produced by the fans. In some environments, for example, where local codes or rules restrict the amount of acceptable noise, the ability to increase fan speed for additional cooling capacity in the condenser may not always be an available option. In an embodiment, increased cooling capacity in the condenser may be achieved by increasing the surface area of the condenser by the addition of an add-on cooling unit 435 as will be presented in FIG. 4.

FIG. 4 is an illustration of a chiller system 400 with the add-on cooling unit 435 according to an embodiment of the present disclosure. The chiller system 400 may include a compressor 410, an evaporator 420, an expansion valve (not shown), and a first condenser 430, which may be cooled from the external source 335 (FIG. 3), for example one or more fans (not shown). The chiller system 400 may be fully operational using the compressor 410, the evaporator 420, and the first condenser 430. However, as discussed in FIG. 3, an additional cooling unit, i.e., an add-on cooling unit 435, may expand the cooling capacity of the system by utilizing at least a second condenser 440 within the add-on cooling unit 435, which may be connected through a coupling 432.

The use of the add-on cooling unit 435 provides the chiller system 400 of FIG. 4 with the ability to run fans that assist in the cooling the first condenser 430 and a second condenser 440 at a slower speed in place of just using the first condenser 430. The use of slower speed fans may also produce a lower noise output from the fans thus enabling operation in environments restricting noise levels. On the other hand, the use of both the first condenser 430 and the second condenser 440 may also expand the capacity of the chiller system 400. Thus, the chiller system 400 configured with both first condenser 430 and second condenser 440 allows for operation in harsher, for example hotter and/or more humid environments where the use of only the first condenser 430 may not be able to provide sufficient cooling. Such operation may be possible where noise restrictions may not be applicable.

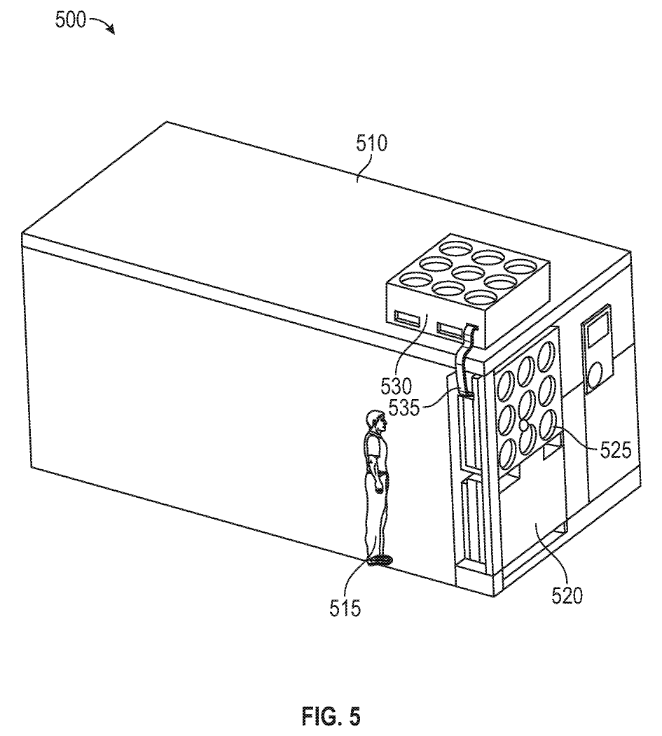

FIG. 5 is a perspective illustration of a battery ESS system 500 with an integrated cooling system 520 and an add-on cooling unit 530, according to an embodiment of the present disclosure. The ESS system 500 may include an ESS system enclosure 510. The system enclosure 510 is illustrated with a human FIG. 515 to represent a possible non-limiting scale. The size and geometry of system enclosure 510 of FIG. 5 is meant to be an example and thus non-limiting.

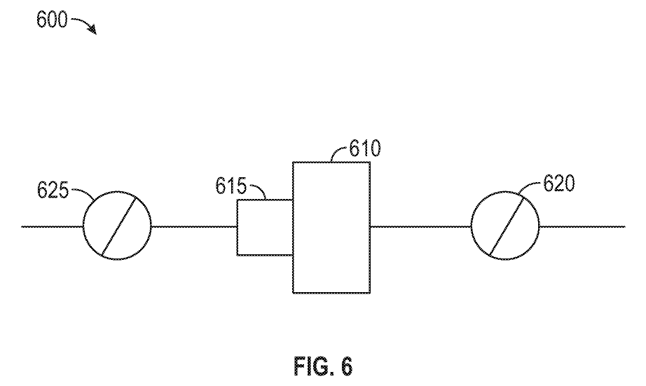

The ESS system 500 may also include the integrated cooling system 520 that includes an integrated first condenser 525. Also shown is the external add-on cooling unit 530 that may be coupled to the integrated first condenser 525 through a coupling 535. Further, coupling 535 may include electrical and refrigerant connections as well as other control and communication connections as necessary. FIG. 6 illustrates additional details regarding coupling 535.

Referring to FIG. 6, a coupling system 600 is between an ESS enclosure and an add-on cooling unit according to another embodiment of the present disclosure. The coupling system 600 may include a first self-sealing quick connect valve 610 and a second self-sealing quick connect valve 615. The coupling system 600 may also include a first manual flow control valve 620 and a second manual flow control valve 625. The first manual flow control valve 620 and the second manual flow control valve 625 may be adjustable thereby varying the amount of refrigerant flow from zero to one hundred percent. The flow control valves 620, 625 may also be used in the process of connecting or disconnecting an add-on cooling unit, for example the add-on cooling unit 435 from the ESS enclosure, e.g., the system enclosure 510 of FIG. 5. Namely, the respective first and second manual flow control valves 620 and 625 may be shut off for the connection or disconnection of the add-on cooling unit thereby preventing the escape of refrigerant from either the integrated first condenser 525, the optional second condenser 435 (FIG. 4), or the add-on cooling unit 530 (FIG. 5). The flow control valves 620 and 625 may also be situated within the cooling unit(s). For example, the first manual flow control valve 620 of FIG. 6 may be situated within the ESS system enclosure 510 of FIG. 5 while the second manual flow control valve 625 may be situated within the add-on cooling unit 530 of FIG. 5.

In addition, the coupling system 600 may utilize hoses suitable for refrigerant use. Further, the coupling system 600 may also include the use of self-sealing quick connect valves, for example, the first self-sealing quick connect valve 610 and the second self-sealing quick connect valve 615, which may simply the connection and disconnection of the add-on cooling unit.

FIG. 7 illustrates a method 700 for expanding battery energy storage system chiller capacity according to an embodiment of the present disclosure. FIG. 7 may begin with process step or logical block B705 with identifying an ESS that includes a plurality of battery modules situated within an enclosure, e.g., as shown in FIGS. 1-2B. As discussed above with reference to FIG. 4, for instance, the chiller system 400 may include the add-on cooling unit 435. The add-on cooling unit 435 is directed to expanding the cooling capacity of an existing ESS 10, 10A, or 10B that includes an existing chiller or cooling system. The add-on cooling unit 435 may be used to expand the cooling capacity of the ESS 10, 10A, or 10B by utilizing at least the second condenser 440 within the add-on cooling unit 435 illustrated in FIG. 4.

Thus, at block B705 the method 700 of FIG. 7 includes identifying an ESS enclosure that may accommodate the add-on cooling unit. As noted above, the ESS enclosure may also be fitted with an external connector that may accommodate a connection between the ESS enclosure and the add-on cooling unit. Further, the use of the add-on cooling unit allows for the use of slower speed fans, resulting in a lower noise output from the fans in a condenser thus enabling operation in environments restricting noise levels. On the other hand, the use of both the first condenser 430 and the second condenser 440 of FIG. 4 also expands the capacity of the chiller system 400. Thus, the chiller system 400 configured with the first condenser 430 and the second condenser 440 allows for operation in harsher, for example hotter and/or more humid environments where the use of only the first condenser 430 may not be able to provide sufficient cooling. Such an operation may be possible where noise restrictions may not be applicable.

At block B710 the method 700 may continue by coupling the first condenser 430 with an add-on cooling unit 435. The add-on cooling unit 435 may be external to the enclosure, and the coupling 432 may include an electrical connection and a refrigerant connection. As discussed above with reference to FIG. 5, the add-on cooling unit 530 may be coupled to the integrated first condenser 525 through the coupling 535. Further, the coupling 535 may include electrical and refrigerant connections as well as other control and communication connections as necessary. The ESS system 500 of FIG. 5 may also include the integrated cooling system 520 that includes an integrated first condenser 525 which is shown with the external add-on cooling unit 530 that may be coupled to the integrated first condenser 525 through the illustrated coupling 535.

At block B715 of FIG. 7, the method 700 may continue with the operating of the ESS 10, 10A, or 10B including the add-on cooling unit, where the add-on cooling unit includes the second condenser, absent a second compressor and a second evaporator. As discussed above with reference to FIG. 4, the chiller system 400 includes the use of an add-on cooling unit 435 that includes the second condenser 440, but without the use of additional compressor or evaporator. Rather, the second condenser 440 is reliant upon compressor 410 and evaporator 420 while working in conjunction with the first condenser 430. As such, there is no need for a second compressor or evaporator within the add-on cooling unit 435.

At block B720, the method 700 may continue with utilizing one or more self-sealing quick connect valves as the coupling. As discussed above with particular reference to FIG. 6, the coupling system 600 may also include the use of self-sealing quick connect valves, for example, the first self-sealing quick connect valve 610 and the second self-sealing quick connect valve 615, which may simplify the connection and disconnection of the add-on cooling unit.

At block B725, the method 700 includes utilization, of the coupling, of a first manual flow control valve situated in the enclosure.

At block B730, the method 700 includes the utilization of a second manual flow control valve as the coupling, with the second manual control valve being situated in the add-on cooling unit. As discussed above with reference to FIG. 6, the coupling system 600 may also include a first manual flow control valve 620 and a second manual flow control valve 625. The first manual flow control valve 620 and the second manual flow control valve 625 may be adjustable, thereby varying the amount of refrigerant flow from zero to one hundred percent. The flow control valves may also be used in the process of connecting or disconnecting an add-on cooling unit, for example the add-on cooling unit 435, from the BESS enclosure, such as BESS system enclosure 510. The first manual flow control valve 620 and the second manual flow control valve 625 may be shut off for the connection or disconnection of the add-on cooling unit thereby preventing the escape of refrigerant from either the integrated first condenser 525 or the second condenser 440 or add-on cooling unit 530.

At block B735, the method 700 may include using hose suitable for refrigerant use. As discussed above with reference to FIG. 3, the condenser 330 handles refrigerant, and thus the hoses within the add-on cooling unit would be suitable for refrigerant use.

Method 700 is complete after block B735.

The present disclosure may be embodied in many different forms. Representative examples are shown in the various drawings and described herein in detail as non-limiting examples of the disclosed principles. To that end, elements and limitations described herein, but not explicitly set forth in the claims, are not to be incorporated into the claims, singly or collectively, by implication, inference, or otherwise.

The present disclosure is susceptible to embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

We claim:

1. A method for energy storage system (ESS) cooling capacity expansion, the method comprising:
identifying an ESS having a plurality of battery modules situated within an enclosure, wherein the enclosure includes an integrated chiller unit having an external coupling for an add-on cooling unit, and wherein the add-on cooling unit includes a condenser, absent a compressor and an evaporator;
coupling the integrated chiller unit with the add-on cooling unit external to the enclosure; and
operating the ESS with the add-on cooling unit.

2. The method of claim 1, wherein coupling the integrated chiller unit includes coupling a condenser, a compressor, an evaporator, and an expansion valve of the integrated chiller unit.

3. The method of claim 1, further comprising:
operating the ESS with the add-on cooling unit in a disabled state.

4. The method of claim 1, further comprising:
removing the add-on cooling unit, thereby leaving the ESS in an operable state.

5. The method of claim 1, wherein the coupling the integrated chiller unit with the add-on cooling unit includes using an electrical connection and a refrigerant connection.

6. The method of claim 1, wherein the coupling the integrated chiller unit with the add-on cooling unit external to the enclosure comprises utilization of a first manual flow control valve situated within the enclosure.

7. The method of claim 1, wherein the coupling the integrated chiller unit with the add-on cooling unit external to the enclosure comprises utilization of a second manual flow control valve situated within the add-on cooling unit.

8. The method of claim 1, further comprising:
servicing the add-on cooling unit by removing the add-on cooling unit from the ESS.

9. The method of claim 8, wherein removing the add-on cooling unit from the ESS includes utilizing a forklift.

10. The method of claim 1, wherein the coupling includes hose suitable for refrigerant use.

11. A system for an energy storage system (ESS) cooling capacity expansion, the system comprising:
an enclosure;
a plurality of battery modules situated within the enclosure; and
an integrated chiller unit that is external to the enclosure and includes an external coupling for an add-on cooling unit, the add-on cooling unit comprising a condenser, absent a compressor and an evaporator.

12. The system of claim 11, wherein the external coupling comprises one or more self-sealing quick connect valves.

13. The system of claim 11, wherein the external coupling comprises a first manual flow control valve situated within the enclosure.

14. The system of claim 11, wherein the external coupling comprises a second manual flow control valve situated within the add-on cooling unit.

15. The system of claim 11, further comprising:
a physical receptacle area within the add-on cooling unit configured to allow lifting of the add-on cooling unit by a lifting device.

16. The system of claim 11, wherein the coupling includes hose suitable for refrigerant use.

17. The system of claim 11, wherein the ESS is configured to be operable without the add-on cooling unit.

18. The system of claim 11, wherein the ESS is configured to be operable with the add-on cooling unit disabled.

19. The system of claim 11, wherein the add-on cooling unit is configured to allow the integrated chiller unit to operate in a reduced noise mode.

20. A method for expanding battery energy storage system (ESS) chiller capacity, the method comprising:
identifying an ESS having a plurality of battery modules situated within an enclosure, wherein the enclosure further includes an integrated chiller unit, and wherein the integrated chiller unit further includes an external coupling for an add-on cooling unit;
coupling the integrated chiller unit with an add-on cooling unit, wherein the add-on cooling unit is external to the enclosure; and
operating the ESS with the add-on cooling unit, wherein the add-on cooling unit includes a condenser, absent a compressor and an evaporator, wherein coupling the integrated chiller unit with an add-on cooling unit includes utilizing:
one or more self-sealing quick connect valves;
a first manual flow control valve situated in the enclosure;
a second manual flow control valve situated in the add-on cooling unit; and
a hose configured for refrigerant use.
